(19) United States
(12) Patent Application Publication
(10) Pub. No.: US 2018/0293547 A1
(43) Pub. Date: Oct. 11, 2018

(54) METHODS AND SYSTEMS FOR EMPLOYMENT AND EDUCATION VERIFICATION USING BLOCKCHAIN

(71) Applicant: JASPREET RANDHAWA, Greenwich, CT (US)

(72) Inventor: JASPREET RANDHAWA, Greenwich, CT (US)

(21) Appl. No.: 15/480,921

(22) Filed: Apr. 6, 2017

(51) Int. Cl. G06Q 10/10; H04L 9/34

(52) U.S. Cl. CPC G06Q 10/1053; H04L 9/34

(57) ABSTRACT

A method for facilitating employment and education verification is disclosed using Blockchain technology. The method includes: a user submitting a change or an update to their online resume using Blockchain. At its core, Blockchain is a network of computers, all of which must approve a transaction has taken place before it is recorded, in a “chain” of computer code; the Users Update is recorded in a Block and made available to all the relevant parties on the network to validate the Users claim regarding the latest update (eg change in title at current company); when all the relevant parties validate the claim, the change is recorded as a permanent record. In this methodology using Blockchain, the information is transparently held in a shared database, without a single body acting as middleman and once the final change is recorded as it cannot be altered or changed. There can only be additions to this data.

### TECHNICAL FIELD

The present disclosure relates to an automated and decentralized method of validating Candidate/Employee's Resume (work and education history) using Blockchain technology.

The present invention is directed to making sure the employment and education information is transparently held in a shared database, without a single body acting as middleman and enabling a distributed consensus, to actually create a true record of events, past and present—create a public ledger using Blockchain technology, which will enable a record to become permanent that can never be changed, only added to.

### DESCRIPTION OF RELATED ART

The current education and employment verification process involves engaging background check companies as a middleman, who do a manual task which not only is time consuming and an expensive task for employers, but has no transparency, is repetitive and often not able to create a true record of events.

### BACKGROUND

The employee verification industry has a problem. The Resume's of candidates are frequently altered to meet the requirements of the advertised job at the given time. Specific contents like actual proof of work, work experience, the employment dates, educational background, education dates are often altered when candidates do not want to show gaps in the employment or mask any deficiencies or inflate achievements to look more suitable for a particular job opening. There is no true record of events and all the information lies with the sole custodian, the individual with the Resume.

### BRIEF DESCRIPTION OF DRAWINGS

Reference will now be made, by way of example, to the accompanying drawings which show example embodiments of the present application and in which:

FIG. 1 diagrammatically shows a possible environment in a flow chart form in which embodiments of the present disclosure may operate.

FIG. 2 shows, in flowchart form, an example method of how the Blockchain Transactions are grouped together into a Block for facilitating employment verification in accordance with example embodiments of the present disclosure.

FIG. 3 shows, how the Blocks are connected in a Blockchain for facilitating employment verification in accordance with example embodiments of the present disclosure.

FIG. 4 shows, what a block looks like, for facilitating employment verification in accordance with example embodiments of the present disclosure.

FIG. 5 shows, how an update (transaction) gets included into block's transactions list for facilitating employment and education verification in accordance with example embodiments of the present disclosure.

### DETAILED DESCRIPTION OF EXAMPLE EMBODIMENTS

In one aspect, the present disclosure describes a software platform doesn't use any centralized computers, but works with a distributed database built using the Blockchain technology. At its core, Blockchain is a network of computers, all of which must approve a transaction has taken place before it is recorded, in a “chain” of computer code; the Users Update is recorded in a Block and made available to all the relevant parties on the network to validate the Users claim regarding the latest update. The Blockchain technology, that maintains a continuously-growing list of data records that each refer to previous items on its list and is thus hardened against tampering and revision. The distributed database will contain candidate data pertaining to the employment history and educational background. At a basic level, the Blockchain can be defined as a distributed public ledger where the information is transparently held in a shared database, without a single body acting as middleman and once the final change is recorded as, it cannot be altered or changed.

A block chain implementation consists of two kinds of records: transactions and blocks. Transactions—Transactions are the content to be stored in the block chain. Transactions are created by participants using the system. In this case a transaction will be an event when a user creates new information in their online profile/resume related to their education or employment. System users create transactions that are passed from node to node on a best-effort basis. The system implementing the block chain defines a valid transaction.

Blocks—Blocks record and confirm when and in what sequence transactions enter and are logged in the block chain. So when the user makes an update about a new job, it will link to that block and will be visible as the latest update.

Other example embodiments of the present disclosure will be apparent to those of ordinary skill in the art from a review of the following detailed descriptions in conjunction with the drawings.

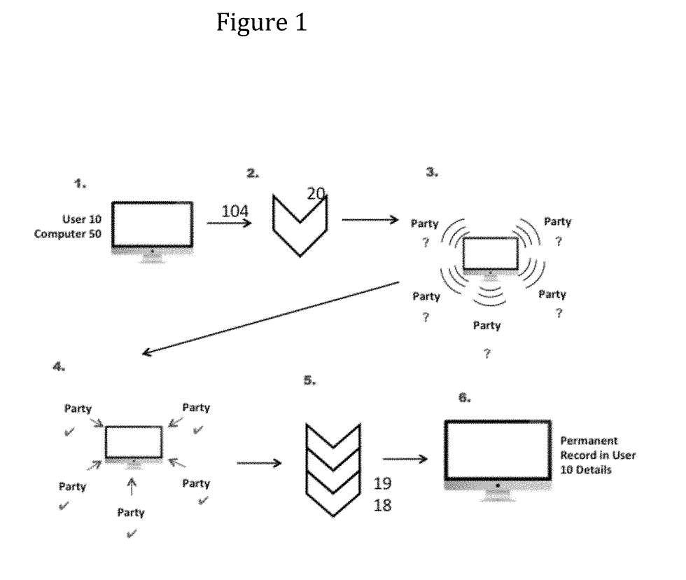

Reference is first made to FIG. 1, which illustrates a flow chart of a possible operating environment in which embodiments of the present disclosure may operate. In the embodiment of FIG. 1, a computer 50 is connected to the network 104 or the world wide web. User 10 makes an update to an existing online resume with new information. In Step 2, the change is represented online as a ‘block’. This is block 20. In Step 3, the ‘block’ (block 20) is broadcast to relevant parties in the network of User 10. In Step 4, the relevant parties approve the update is valid and true. In Step 5, the block can then be added to the chain, which provides an indelible and transparent record of the update. Block 20 is added on top of Block 19, which was originally added on top of Block 18. The final, validated update for User 10 is posted as a permanent record in Step 6.

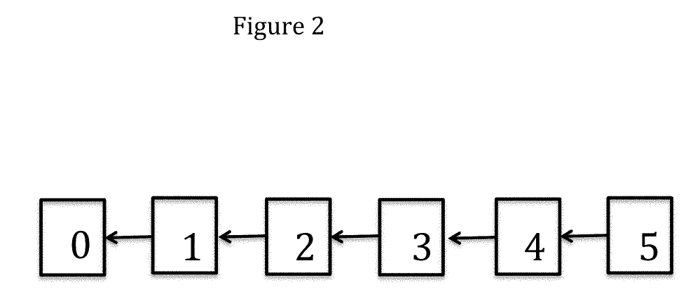

Reference is now made to FIG. 2, which shows, an example method of how the Blockchains Transactions are grouped together into a Block. The Chain is multiple Blocks, linked together. 0 1 2 3 4 5. Blocks are numbered in ascending order, 0 is first/oldest. The number is the ‘height’ of the block. Arrows only go from newer to older blocks—a block only directly links to the one immediately before it. Once a block is stored, it's read-only. Blocks store data, it could be any digital data that relates the individuals professional or educational background. Blocks are created periodically as the user updates their Resume with additional information on their Education or Employment. A block represents a set of events that have occurred over a particular time frame (usually, since the previous block or the last update).

Blocks will not be identified by their height, but by their id. The Block id is the hash of the data in the block

### 0=000000000019D6689C085AE165831E934FF763AE46A2A6C172B3F1B60A8CE26F

### 1=00000000839A8E6886AB5951D76F411475428AFC90947EE320161BBF18EB6048

### 2=000000006A625F06636B8BB6AC7B960A8D03705D1ACE08B1A19DA3FDCC99DDBD

Block id is a digital fingerprint of that block.

What's in a block? A ‘magic number’ (0xD9B4BEF9) to show it's a block belonging to the Employment Verification technology suite. A size number to specify how much data is coming next. Some metadata:

A version number of the block format
A link to the previous block that came immediately before it
Merkle root of all the transactions in the block
Timestamp of when the block was created
Mining difficulty (more about this later)
Nonce for proof-of-work
All the transactions are recorded in this block

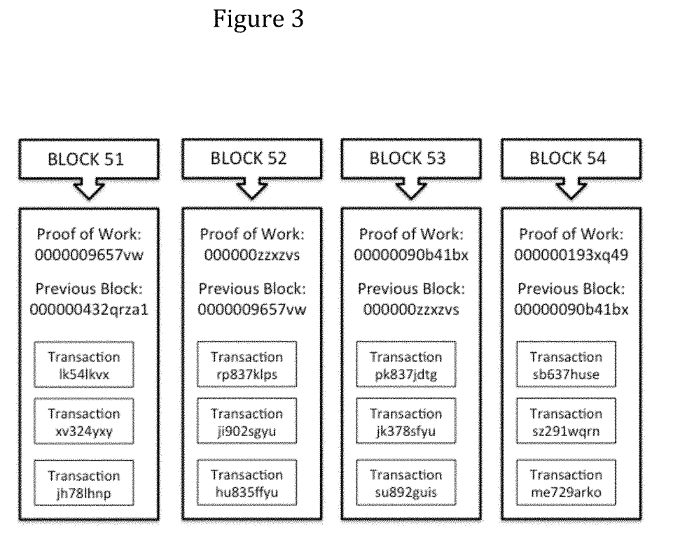

Reference is now made to FIG. 3, which shows how Blocks are connected in the Blockchain. It works by adding new blocks following each update/transaction one-by-one in a linear fashion providing a full history of every transaction in the chain. It is a simple concept—a digital record of digital events that is shared between many different parties. When a user wants to send something digitally to another user over the Blockchain the data that is required (including the details of the sender, receiver and any supplementary information) to complete the transaction will be sent out into the ecosystem and scrambled, along with a number of other transactions that are made at a similar time. The nodes that maintain the network will then begin collating all these transactions into a single block.

Once complete, the block will be confirmed and then attached to the chain as the newest transaction block not only including the latest transactions but all transactions that have gone before it. For this to happen however, the block must be confirmed by all the nodes by being processed through a series of algorithms to create a proof of work number. Once this number has been created, it will send this out to the network which will recognize and confirm this number as being unique and the transaction will be confirmed and be irrefutable. The network will then begin to start work on a new block—following the same process. What this means is that the Blockchain can only be updated through the agreement of the majority of participants in the system.

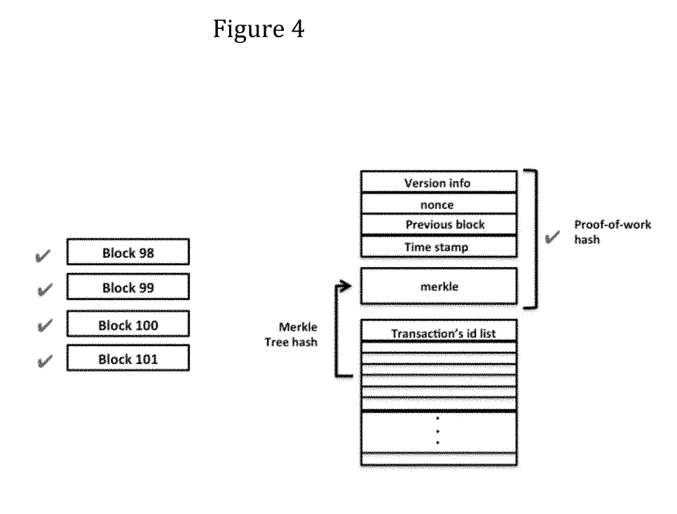

Reference is now made to FIG. 4, which shows what does a block looks like. Block chain Simplified block structure: Issues Header—Contains service information (version info, nonce, previous block id and timestamp).—A summary built from the block's transaction identifiers. Merkle Transaction's id list—list of transaction's identification hashes, that was included into the block's merkle tree version info transaction's id list previous block nonce Merkle Merkle tree hash Proof-of-work hash timestamp Block 98 Block 99 Block 100 Block 101

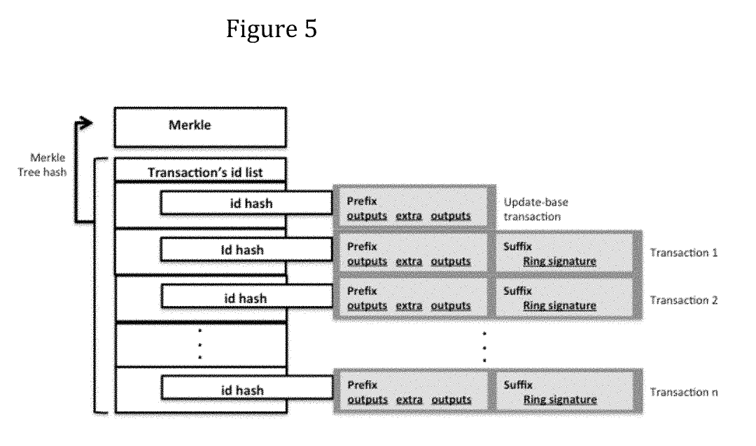

Reference is now made to FIG. 5, which shows how an update (transaction) gets included into block's transactions list by an by identifier calculated from transaction prefix only. This allows to cut-off ring signatures from old transactions but still able to prove that transactions. Belong to given block and protected by Proof-of-Work of this block update—base transaction transaction 1 transaction 2 transaction n transaction's id list Merkle prefix prefix prefix suffix suffix suffix Merkle tree hash id hash id hash id hash id hash extra extra extra outputs outputs outputs outputs outputs ring signature ring signature ring signature coin—base transaction transaction 1 transaction 2 transaction n transaction's id list Merkle prefix prefix prefix suffix suffix suffix Merkle tree hash id hash id hash id hash id hash extra extra extra outputs outputs outputs outputs outputs ring signature ring signature ring signature prefix extra outputs prefix extra outputs outputs outputs.

Example embodiments of the present application are not limited to any particular operating system, system architecture, mobile device architecture, server architecture, or computer programming language.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A software solution using Blockchain technology for facilitating employment and education verification, comprising:
a user submitting a change or an update to their online resume using Blockchain; the Users Update is recorded in a Block and made available to all the relevant parties on the network to validate the Users claim regarding the latest update (eg change in title at current company); when all the relevant parties validate the claim, the change is recorded as a permanent record. In this methodology using Blockchain, the information is transparently held in a shared database, without a single body acting as middleman and once the final change is recorded as it cannot be altered or changed. There can only be additions to this data.

2. The method of claim 1, wherein identifying that all data related to an individual's employment and education will be recorded on a public ledger.

3. The method of claim 2, wherein determining that all the information related to an individual's employment and education is transparently held in a shared database, in a digital public ledger that anyone on the network can see without a single body acting as middleman or being the sole custodian of the data.

4. The method of claims 1 and 3, further identifying, that all updates and data is verified as it happens, updated to employment records or changes in education. By enabling this distributed consensus, it can actually create a true record of events, past and present, in the digital world.

5. The method of claim 1, further identifying, that once updated, the ledger cannot be altered or tampered with, it can only be added to. All changes are final and every dataset and every digital update will leave a “fingerprint” there, creating an audit trail.
